(19) United States
(12) Patent Application Publication
(10) Pub. No.: US 2026/0138063 A1
(43) Pub. Date: May 21, 2026

(54) AIR PURIFYING FILTER CLEANING APPARATUS AND OPERATING METHOD THEREOF

(71) Applicants: Samsung Electronics Co., Ltd., Suwon-si (KR); jk global co., ltd, Hwaseong-si (KR)

(72) Inventors: Dong Sik Yang, Suwon-si (KR); Jonghyun Ha, Suwon-si (KR); Taehun Yeon, Hwaseong-si (KR); Hyun Chul Lee, Suwon-si (KR); Hyukjae Kwon, Suwon-si (KR); Dongjin Ham, Suwon-si (KR)

(21) Appl. No.: 19/279,317

(22) Filed: Jul. 24, 2025

(30) Foreign Application Priority Data
Nov. 19, 2024 (KR) 10-2024-0165641

(51) Int. Cl. B01D 29/68

(52) U.S. Cl. CPC B01D 29/68; B01D 2201/081

(57) ABSTRACT

An air purifying filter cleaning apparatus for cleaning an air purifier including an air purifying filter disposed between a contaminated air inlet and a purified air outlet. The air purifying filter cleaning apparatus includes: a nozzle portion disposed to face the purified air outlet and for discharging a first cleaning solution to the purified air outlet; a cleaning solution storage in which a second cleaning solution discharged from the contaminated air inlet is collected; a first purifier for removing contaminants contained in the second cleaning solution received from the cleaning solution storage; a first storage tank in which a third cleaning solution, which is a solution remaining after the contaminants are removed from the second cleaning solution by the first purifier, is stored, and a pressurizer for supplying the third cleaning solution stored in the first storage tank to the nozzle portion.

### CROSS-REFERENCE TO RELATED APPLICATION

This application claims priority to Korean Patent Application No. 10-2024-0165641, filed on Nov. 19, 2024, and all the benefits accruing therefrom under 35 U.S.C. § 119, the content of which in its entirety is herein incorporated by reference.

### BACKGROUND

### 1. Field

The disclosure relates to an air purifying filter cleaning apparatus for cleaning an air purifying filter provided in an air purifier and an operating method thereof.

### 2. Description of the Related Art

Air purifiers purify air by collecting or decomposing particulate matter and contaminants in gas, for example, air. Air purifiers may be applied to industrial dust collection facilities, air conditioning/ventilation systems in buildings, etc.

To remove contaminants contained in air, a method of removing contaminants by using porous materials with a large specific surface area or decomposing contaminants by using photocatalysts is commonly used. Examples of the porous materials with a large specific surface area include ceramic filters. The photocatalysts that decompose contaminants require a separate light source and energy.

When contaminants are adsorbed onto filters, the adsorption capacity of the filters may be limited. To recycle the filters, heat may be applied to the filters, or contaminants may be removed by using a cleaning solution.

### SUMMARY

Provided are an air purifying filter cleaning apparatus for removing contaminants adsorbed onto an air purifying filter so as to reuse the air purifying filter and an operating method of the air purifying filter cleaning apparatus.

Provided are an air purifying filter cleaning apparatus, in which a cleaning solution is reused so that the consumption of the cleaning solution is reduced, and the weight of the air purifying filter cleaning apparatus is reduced, and an operating method of the air purifying filter cleaning apparatus.

Provided are an air purifying filter cleaning apparatus, in which a cleaning solution sprayed from a nozzle portion is introduced into a purified air outlet so as to improve a cleaning rate, and an operating method of the air purifying filter cleaning apparatus.

Provided are an air purifying filter cleaning apparatus, in which energy efficiency is improved in a process of removing contaminants adsorbed onto an air purifying filter, and an operating method of the air purifying filter cleaning apparatus.

Provided are an air purifying filter cleaning apparatus, in which design convenience is improved by configuring a nozzle portion to spray a cleaning solution to correspond to air purifying filters of various specifications, and an operating method of the air purifying filter cleaning apparatus.

Provided are an air purifying filter cleaning apparatus, in which a cleaning state of an air purifying filter is sensed to determine whether to recycle the air purifying filter, and an operating method of the air purification filter cleaning apparatus.

Additional aspects will be set forth in part in the description which follows and, in part, will be apparent from the description, or may be learned by practice of the presented embodiments of the disclosure.

According to an aspect of the disclosure, provided is an air purifying filter cleaning apparatus for cleaning an air purifier including a contaminated air inlet into which contaminated air is introduced and a purified air outlet through which purified air is discharged, where an air purifying filter is disposed between the contaminated air inlet and the purified air outlet, the air purifying filter cleaning apparatus including a nozzle portion disposed to face the purified air outlet and configured to discharge a first cleaning solution to the purified air outlet, a cleaning solution storage in which a second cleaning solution discharged from the contaminated air inlet is collected, a first purifier configured to remove contaminants contained in the second cleaning solution received from the cleaning solution storage, a first storage tank in which a third cleaning solution, which is a solution remaining after the contaminants are removed from the second cleaning solution by the first purifier, is stored, and a pressurizer configured to supply the third cleaning solution stored in the first storage tank to the nozzle portion.

The nozzle portion may include a plurality of nozzles, and the plurality of nozzles may be spaced apart from each other at certain intervals.

A first interval along a first direction and a second interval along a second direction perpendicular to the first direction between nozzles disposed adjacent to each other among the plurality of nozzles may be adjustable differently from each other.

The first cleaning solution discharged from the nozzle portion may include at least one of water or ethanol.

The first cleaning solution may be discharged from the nozzle portion at a flow rate of about 150 liters per minute (L/min) to about 200 L/min.

The first cleaning solution may be discharged from the nozzle portion at a flow velocity of about 1.0 centimeter per second (cm/s) to about 1.5 cm/s.

The pressurizer may be further configured to adjust a flow velocity and a flow rate of the first cleaning solution by applying pressure to the first cleaning solution discharged from the nozzle portion.

The air purifying filter cleaning apparatus may further include a fastening portion configured to fix the air purifier such that one surface of the air purifier where the purified air outlet is disposed faces the nozzle portion.

The air purifying filter cleaning apparatus may further include a first sensor configured to sense electrical conductivity of the air purifying filter.

The air purifying filter cleaning apparatus may further include a second sensor configured to sense turbidity of the air purifying filter.

The air purifying filter cleaning apparatus may further include a processor configured to perform control to repeat a recycling process in which the third cleaning solution is supplied to the nozzle portion according to the electrical conductivity or the turbidity of the air purifying filter sensed by the first sensor or the second sensor.

The air purifying filter cleaning apparatus may further include a third sensor configured to sense electrical conductivity of the third cleaning solution.

The air purifying filter cleaning apparatus may further include a second purifier configured to remove contaminants contained in the third cleaning solution received from the first storage tank, and a second storage tank in which a fourth cleaning solution, which is a solution remaining after the contaminants are removed from the third cleaning solution by the second purifier, is stored, and the pressurizer may further be configured to supply the fourth cleaning solution stored in the second storage tank to the nozzle portion.

The air purifying filter may include a porous filter, and the air purifier may include a coating portion coated with a catalyst on one surface of the air purifying filter.

According to another aspect of the disclosure, provided is an operating method of the air purifying filter cleaning apparatus, the operating method including mounting the air purifier on the air purifying filter cleaning apparatus such that the nozzle portion faces the purified air outlet, spraying the first cleaning solution from the nozzle portion, collecting, in the cleaning solution storage, the second cleaning solution discharged from the contaminated air inlet, removing contaminants contained in the second cleaning solution collected in the cleaning solution storage by using the first purifier, storing, in the first storage tank, the third cleaning solution, and supplying the third cleaning solution stored in the first storage tank to the nozzle portion.

The nozzle portion may include a plurality of nozzles, the plurality of nozzles may be spaced apart from each other at certain intervals, and a first interval along a first direction and a second interval along a second direction perpendicular to the first direction between nozzles disposed adjacent to each other among the plurality of nozzles may be adjustable differently from each other according to a cross-sectional area and an arrangement interval of the purified air outlet.

The operating method may further include adjusting a flow velocity and a flow rate of the first cleaning solution discharged from the nozzle portion.

The operating method may further include sensing electrical conductivity of the air purifying filter.

The operating method may further include sensing turbidity of the air purifying filter.

The operating method may further include repeating a recycling process of the third cleaning solution supplied from the nozzle portion according to the electrical conductivity or the turbidity of the air purifying filter.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic configuration diagram of an air purifying filter cleaning apparatus according to an embodiment;

FIG. 2 is a perspective view of an air purifier according to an embodiment;

FIG. 3 is a schematic cross-sectional view of an air purifier according to an embodiment;

FIG. 4 is a plan view of a cleaning solution spraying device according to an embodiment;

FIG. 5 is a cross-sectional side view of a cleaning solution spraying device according to an embodiment;

FIG. 6 is a schematic diagram of an air purifier according to an embodiment, which is mounted on a cleaning solution spraying device so that a first cleaning solution is introduced into the air purifier;

FIG. 7 is a schematic diagram illustrating purification of an air purifier according to Comparative Example 1;

FIG. 8 is a schematic diagram illustrating purification of an air purifier according to Comparative Example 2;

FIG. 9 is a graph for comparing purification efficiencies of air purifying filter cleaning apparatuses according to an embodiment, Comparative Example 1, and Comparative Example 2;

FIG. 10 is a graph showing a change in electrical conductivity and turbidity of an air purifier according to an embodiment;

FIG. 11 is a graph showing a change in differential pressure before and after cleaning according to the number of recycling cycles of an air purifying filter according to an embodiment;

FIG. 12 is a graph showing a contaminant removal rate and a change in differential pressure according to the number of recycling cycles of an air purifying filter according to an embodiment;

FIG. 13 is a flowchart showing an operating method of an air purifying filter cleaning apparatus, according to an embodiment; and

FIG. 14 is a flowchart showing an operating method of an air purifying filter cleaning apparatus, according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. As used herein, the term “and/or” includes any and all combinations of one or more of the associated listed items. Expressions such as “at least one of,” when preceding a list of elements, modify the entire list of elements and do not modify the individual elements of the list. Throughout the disclosure, the expression “at least one of a, b or c” indicates only a, only b, only c, both a and b, both a and c, both b and c, all of a, b, and c, or variations thereof. “At least one” is not to be construed as limiting “a” or “an.” “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

“About” or “substantially the same” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10%, 5% or 2% of the stated value.

Hereinafter, embodiments will be described in detail with reference to the accompanying drawings. In the following drawings, the same reference numerals denote the same elements, and the size of each element in the drawings may be exaggerated for clarity and convenience of explanation.

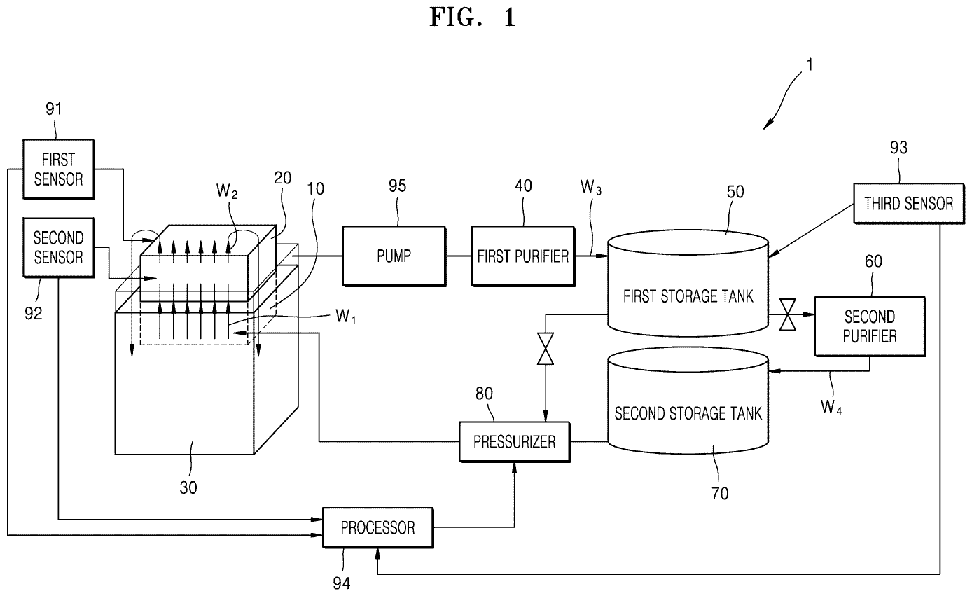

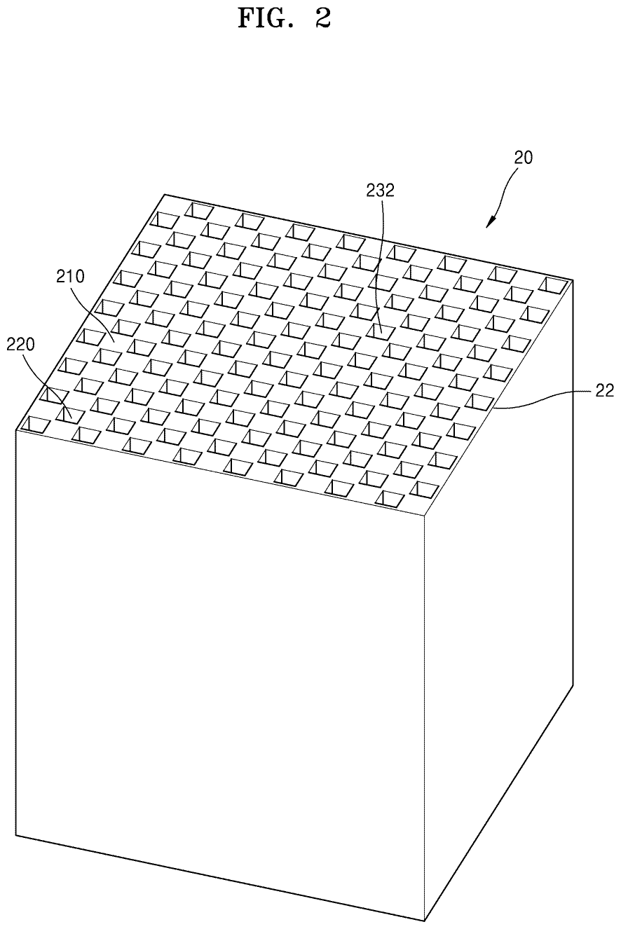

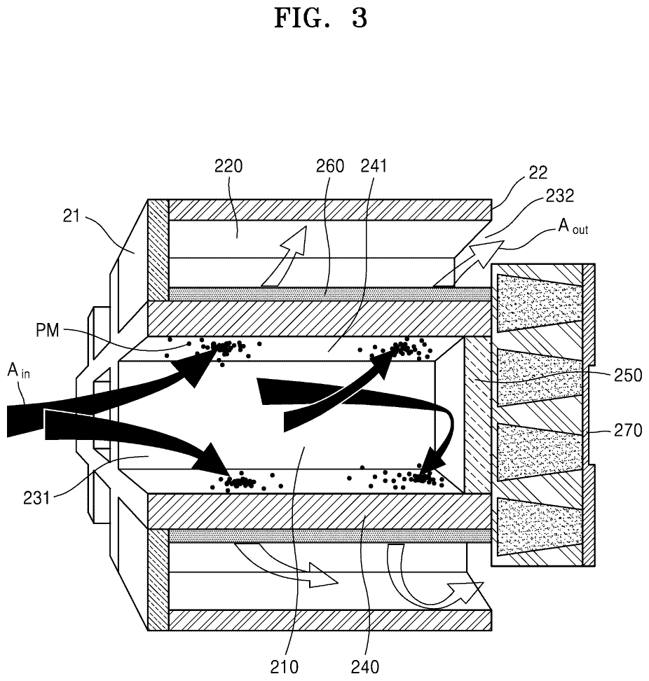

FIG. 1 is a schematic configuration diagram of an air purifying filter cleaning apparatus 1 according to an embodiment. FIG. 2 is a perspective view of an air purifier 20 according to an embodiment. FIG. 3 is a schematic cross-sectional view of the air purifier 20 according to an embodiment.

Referring to FIG. 1, the air purifying filter cleaning apparatus 1 according to an embodiment may include a cleaning solution spraying device 10 including a nozzle portion 100 through which a first cleaning solution W₁ is sprayed, a cleaning solution storage 30 that collects a second cleaning solution W₂ having cleaned the air purifier 20 using the first cleaning solution W₁, a first purification portion 40 (e.g., purifier) that removes contaminants contained in the second cleaning solution W₂, a first storage tank 50 that stores a third cleaning solution W₃ in which contaminants contained in the second cleaning solution W₂ have been removed by passing through the first purification portion 40, a second purification portion 60 (e.g., purifier) that removes contaminants contained in the third cleaning solution W₃, a second storage tank 70 that stores a fourth cleaning solution W₄ in which contaminants contained in the third cleaning solution W₃ have been removed by passing through the second purification portion 60, a pressurizer 80 that supplies a recycled cleaning solution to the nozzle portion 100, a first sensor 91 and a second sensor 92 that sense a contamination level of the air purifier 20, and a third sensor 93 that senses a contamination level of the third cleaning solution W₃ stored in the first storage tank 50, and a processor 94.

Referring to FIGS. 2 and 3, the air purifier 20 according to an embodiment may include a contaminated air inlet 231 into which contaminated air Aᵢₙ is introduced, a first channel 210 and a second channel 220 through which the contaminated air Aᵢₙ is movable, an air purifying filter 240 disposed between the first channel 210 and the second channel 220 to adsorb and remove contaminants contained in the contaminated air Aᵢₙ, a coating portion 260 coated with a catalyst, and a purified air outlet 232 through which purified air Aₒᵤₜ purified by the air purifying filter 240 and the coating portion 260 is discharged.

The term “contaminated air Aᵢₙ” as used herein refers to mixed gas including air and at least one of particulate matter PM, a water-soluble organic compound, or a water-insoluble organic compound. For example, the particulate matter PM may include particulate matter of 10 micrometers (μm) or less and ultrafine particulate matter of 2.5 μm or less. In addition, the water-soluble organic compound may be a volatile organic compound and may include a gaseous material, such as ammonia (NH₃), acetaldehyde (CH₃CHO), or acetic acid (CH₃COOH), which may be captured by water or an aqueous solution and then removed. In addition, the water-insoluble organic compound is a volatile organic compound that is not captured by water or an aqueous solution, and may include, for example, benzene (C₆H₆), formaldehyde (CH₂O), toluene (C₆H₅CH₃), etc. However, the disclosure is not limited thereto, and any other gas, except for the particulate matter PM, the water-soluble organic compound, and the water-insoluble organic compound, may be included in the contaminated air Aᵢₙ.

The contaminated air inlet 231 is a passage through which the contaminated air Aᵢₙ may be introduced. According to an embodiment, the contaminated air inlet 231 may be disposed on one surface 21 of the air purifier 20 in a grid shape. The contaminated air inlet 231 may be connected to the first channel 210. Accordingly, the contaminated air Aᵢₙ passing through the contaminated air inlet 231 may be introduced into the first channel 210.

The first channel 210 is a fluid movement path through which the contaminated air Aᵢₙ is movable. According to an embodiment, one end portion of the first channel 210 may be the contaminated air inlet 231 through which the contaminated air Aᵢₙ may be introduced, as described above, and a blocking wall 250 may be disposed at the other end portion of the first channel 210. In this case, the air purifying filter 240 including a porous material may be disposed on the side of the first channel 210 extending from the contaminated air inlet 231 to the blocking wall 250. Accordingly, the contaminated air Aᵢₙ introduced into the first channel 210 through the contaminated air inlet 231 may be introduced into the second channel 220 through the air purifying filter 240.

The air purifying filter 240 may be a porous filter. The air purifying filter 240 may include a porous material, for example, at least one of a polymer, a ceramic, or a metal material. The shape of the air purifying filter 240 may be at least one of mesh, foam, woven fabric, non-woven fabric, or a honeycomb structure, but the disclosure is not limited thereto.

The coating portion 260 may be disposed on one surface of the air purifying filter 240. According to an embodiment, the coating portion 260 may include a catalytic material capable of removing the volatile organic compound contained in the contaminated air Aᵢₙ. For example, the coating portion 260 may include a photocatalytic material that is activated by ultraviolet (“UV”) light emitted from a light source 270 and removes the volatile organic compound, such as formaldehyde (CH₂O). However, the disclosure is not limited thereto, and the coating portion 260 may include any organic/inorganic composite catalyst capable of removing organic compounds other than the particle matter contained in the contaminated air Aᵢₙ.

According to an embodiment, the air purifying filter 240 and the coating portion 260 may be disposed across the flow path of the contaminated air Aᵢₙ between the upstream and the downstream of the flow of the contaminated air Aᵢₙ. For example, the air purifying filter 240 and the coating portion 260 may be disposed so that the flow of the contaminated air Aᵢₙ sequentially passes through one surface of each of the air purifying filter 240 and the coating portion 260 and the other surface of the air purifying filter 240 opposite to the one surface thereof. For example, the air purifying filter 240 may be disposed upstream of the flow of the contaminated air Aᵢₙ, compared to the coating portion 260. That is, the air purifying filter 240 may be disposed so that the air purifying filter 240 first comes into contact with the flow of the contaminated air Aᵢₙ, compared to the coating portion 260.

According to an embodiment, the contaminated air Aᵢₙ may move through the first channel 210, sequentially pass through one surface of each of the air purifying filter 240 and the coating portion 260 and the other surface of the air purifying filter 240 opposite to the one surface thereof, and be then introduced into the second channel 220. In the process in which the contaminated air Aᵢₙ passes through the one surface of each of the air purifying filter 240 and the coating portion 260 and the other surface of the air purifying filter 240 opposite to the one surface thereof, the particulate matter PM may be adsorbed onto the air purifying filter 240, and the volatile organic compound, for example, formaldehyde (CH₂O), may be removed by the catalyst included in the coating portion 260. Accordingly, the purified air Aₒᵤₜ introduced into the second channel 220 may be discharged to the outside through the purified air outlet 232.

As described above, because the air purifying filter 240 is disposed so that the contaminated air Aᵢₙ first comes into contact with the air purifying filter 240, compared to the coating portion 260, the particulate matter PM may be adsorbed onto one surface 241 of the air purifying filter 240 disposed upstream of the flow of the contaminated air Aᵢₙ. In other words, the particulate matter PM may be adsorbed onto one surface 241 of the air purifying filter 240 constituting a sidewall of the first channel 210. When the particulate matter PM is continuously adsorbed onto one surface 241 of the air purifying filter 240, the purification ability for the contaminated air Aᵢₙ may be reduced. Accordingly, the purification ability for the contaminated air Aᵢₙ may be improved through the recycling process for the air purifying filter 240.

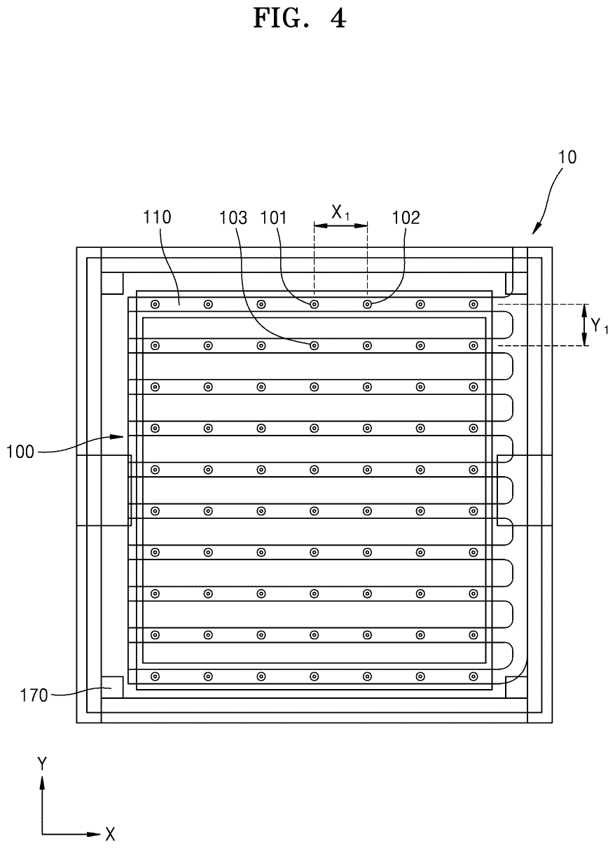

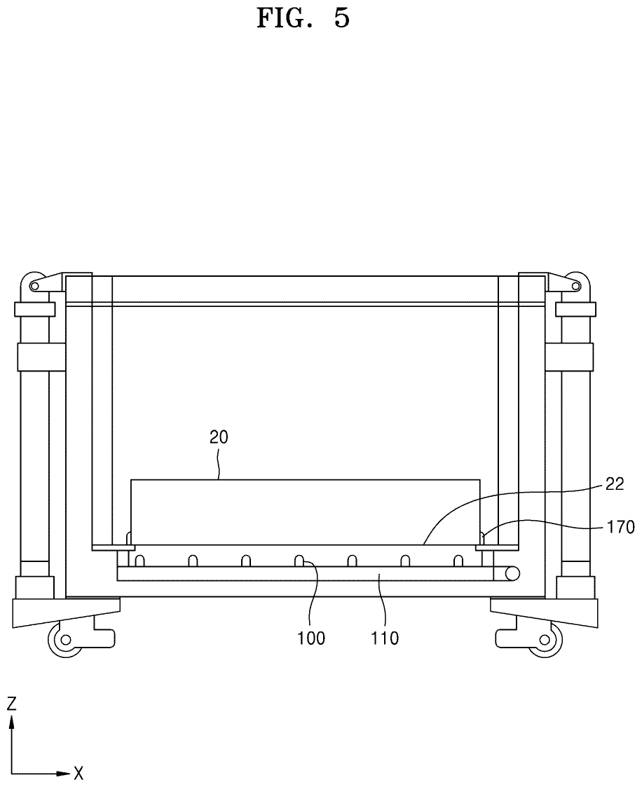

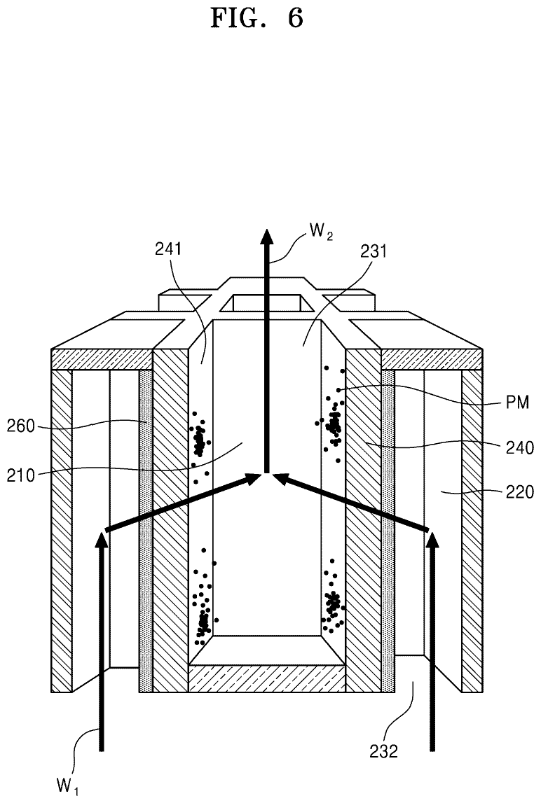

FIG. 4 is a plan view of a cleaning solution spraying device according to an embodiment. FIG. 5 is a cross-sectional side view of the cleaning solution spraying device according to an embodiment. FIG. 6 is a schematic diagram of an air purifier according to an embodiment, which is mounted on the cleaning solution spraying device so that a first cleaning solution is introduced into the air purifier.

Referring to FIGS. 1 and 4 to 6, the cleaning solution spraying device 10 according to an embodiment may include a nozzle portion 100 through which a cleaning solution is sprayed, a cleaning solution supply portion 110 in which the nozzle portion 100 is disposed and which supplies the cleaning solution to the nozzle portion 100, and a fastening portion 170 that fixes the air purifier 20 to the cleaning solution spraying device 10. The term “cleaning solution” as used herein refers to any fluid capable of removing contaminants adsorbed onto the air purifying filter 240, such as the particulate matter PM, from the air purifying filter 240. For example, the cleaning solution may include at least one of water or ethanol, which may remove the particulate matter PM from the air purifying filter 240. However, the disclosure is not limited thereto, and the cleaning solution may include other fluids capable of removing other contaminants, except for the particulate matter PM, the water-soluble organic compound, and the water-insoluble organic compound, from the air purifying filter 240.

The nozzle portion 100 may be disposed to face the purified air outlet 232, and the first cleaning solution W₁ discharged from the nozzle portion 100 may be introduced into the second channel 220 through the purified air outlet 232. According to an embodiment, as illustrated in FIG. 2, a plurality of purified air outlets 232 may be disposed on one surface 22 of the air purifier 20 in a grid shape, and a plurality of contaminated air inlets 231 corresponding to the plurality of purified air outlets 232 may be disposed on the other surface 21 of the air purifier 20 in a grid shape.

In an embodiment, when a plurality of purified air outlets 232 are provided, a plurality of nozzles in the nozzle portion 100 disposed to face the plurality of purified air outlets 232 may also be provided. When a plurality of nozzles in the nozzle portion 100 are provided, the plurality of nozzles in the nozzle portion 100 may be spaced apart from each other at certain intervals. For example, adjacent nozzles among the plurality of nozzles in the nozzle portion 100 may be spaced apart from each other at a first interval X₁ along a first direction X and a second interval Y₁ along a second direction Y perpendicular to the first direction X, and the first interval X₁ and the second interval Y₁ may be adjusted differently.

For example, when the plurality of nozzles in the nozzle portion 100 include a first nozzle 101 and a second nozzle 102 spaced apart along the first direction X, the first interval X₁ between the first nozzle 101 and the second nozzle 102 may be adjusted differently according to the arrangement interval of the purified air outlets 232. For example, when the first nozzle 101 and the second nozzle 102 are spaced apart from each other at the first interval X₁ in the cleaning solution supply portion 110 extending along the first direction X, the first interval X₁ between the first nozzle 101 and the second nozzle 102 may be changed by adjusting the arrangement positions of the first nozzle 101 and the second nozzle 102 on the cleaning solution supply portion 110.

In addition, according to an embodiment, when the plurality of nozzles in the nozzle portion 100 include a first nozzle 101 and a third nozzle 103 spaced apart along the second direction Y, the second interval Y₁ between the first nozzle 101 and the third nozzle 103 may be adjusted differently according to the arrangement interval of the purified air outlets 232. For example, when the first nozzle 101 and the third nozzle 103 are spaced apart from each other at the second interval Y₁ along the second direction Y, the second interval Y₁ between the first nozzle 101 and the third nozzle 103 may be changed by adjusting the arrangement positions of the cleaning solution supply portion 110 in which the first nozzle 101 is disposed and the cleaning solution supply portion 110 in which the third nozzle 103 is disposed.

In addition, according to an embodiment, the fastening portion 170 may fix the air purifier 20 to the cleaning solution spraying device 10 such that one surface 22 of the air purifier 20 in which the purified air outlet 232 is disposed faces the nozzle portion 100. In this case, the fastening portion 170 may be provided in plurality and disposed to be movable on one plane (an X-Y plane). Accordingly, the fastening portion 170 may fix the air purifier 20 to the cleaning solution spraying device 10 such that one surface 22 of the air purifier 20 faces the nozzle portion 100 so as to correspond to the air purifier 20 having a different area and shape.

As described above, each of the plurality of nozzles in the nozzle portion 100 may be movable along the first direction X or the second direction Y. In addition, as a relative position of the air purifier 20 fixed to the cleaning solution spraying device 10 is adjusted by the fastening portion 170, the positions of the plurality of nozzles in the nozzle portion 100 and the positions of the plurality of purified air outlets 232 may be adjusted to correspond to each other. Accordingly, the first cleaning solution W₁ discharged from each of the plurality of nozzles in the nozzle portion 100 may be introduced into the plurality of purified air outlets 232. However, the disclosure is not limited thereto, and the mutual positions of the plurality of nozzles in the nozzle portion 100 and the plurality of purified air outlets 232 may be adjusted according to the cross-sectional area and arrangement density of each of the plurality of purified air outlets 232.

According to an embodiment, the first cleaning solution W₁ discharged from the nozzle portion 100 may have a pressure capable of desorbing contaminants adsorbed onto the air purifying filter 240, such as the particulate matter PM, from the air purifying filter 240. According to an embodiment, the pressurizer 80 may apply pressure to the first cleaning solution W₁ discharged from the nozzle portion 100, and accordingly, the flow velocity and the flow rate of the first cleaning solution W₁ may be adjusted. For example, the pressurizer 80 may be a pump. However, the disclosure is not limited thereto, and in another embodiment, the pressurizer 80 may be replaced with any pressurizer capable of applying pressure to the first cleaning solution W₁ to adjust the flow velocity and the flow rate of the first cleaning solution W₁.

According to an embodiment, the first cleaning solution W₁ discharged from the nozzle portion 100 may have a certain flow velocity and a certain flow rate capable of desorbing contaminants adsorbed onto the air purifying filter 240 by receiving pressure from the pressurizer 80. For example, the first cleaning solution W₁ discharged from the nozzle portion 100 may have a flow rate of about 150 L/min to about 200 L/min. In addition, for example, the first cleaning solution W₁ discharged from the nozzle portion 100 may have a flow velocity of about 1.0 cm/s to about 1.5 cm/s.

However, the disclosure is not limited thereto, and the flow velocity and the flow rate of the first cleaning solution W₁ discharged from the nozzle portion 100 may be determined differently according to the type of contaminants adsorbed onto the air purifying filter 240, for example, the particulate matter PM, the thickness and porosity of the air purifying filter 240 and the coating portion 260, the cross-sectional area of the purified air outlet 232, and the relative arrangement density of the purified air outlet 232 and the nozzle portion 100.

According to an embodiment, when the first cleaning solution W₁ sprayed from the nozzle portion 100 is introduced into the purified air outlet 232, the first cleaning solution W₁ may pass through the second channel 220 and the first channel 210 and be discharged to the outside through the contaminated air inlet 231. In this case, the air purifying filter 240 and the coating portion 260 according to an embodiment may be disposed across the flow path of the first cleaning solution W₁ between the upstream and the downstream of the flow of the first cleaning solution W₁. For example, the air purifying filter 240 and the coating portion 260 may be disposed so that the flow of the first cleaning solution W₁ sequentially passes through one surface of each of the air purifying filter 240 and the coating portion 260 and the other surface of the air purifying filter 240 opposite to the one surface thereof. For example, the coating portion 260 may be disposed upstream of the flow of the first cleaning solution W₁, compared to the air purifying filter 240. That is, the coating portion 260 may be disposed to first come into contact with the flow of the first cleaning solution W₁, compared to the air purifying filter 240.

According to an embodiment, as the first cleaning solution W₁ first comes into contact with the coating portion 260, then comes into contact with the air purifying filter 240, and is introduced into the first channel 210, so that contaminants adsorbed onto one surface 241 of the air purifying filter 240, for example, the particulate matter PM, may be desorbed by the first cleaning solution W₁ and introduced into the first channel 210 together with the first cleaning solution W₁. After the second cleaning solution W₂ containing contaminants (e.g., particulate matter PM) and the first cleaning solution W₁ is introduced into the first channel 210, the second cleaning solution W₂ may pass through the contaminated air inlet 231 and be discharged to the outside of the air purifier 20.

As described above, as the first cleaning solution W₁ sprayed from the nozzle portion 100 is introduced into the purified air outlet 232, the first cleaning solution W₁ may first come into contact with the coating portion 260, then come into contact with the air purifying filter 240, and be introduced into the first channel 210. Accordingly, the contaminant cleaning efficiency may be improved by preventing a phenomenon in which the contaminants adsorbed onto one surface 241 of the air purifying filter 240 are adsorbed again onto the air purifying filter 240 and the coating portion 260.

Referring again to FIG. 1, the second cleaning solution W₂ discharged to the outside of the air purifier 20 may be collected in the cleaning solution storage 30. According to an embodiment, the cleaning solution storage 30 may be a storage that temporarily stores the second cleaning solution W₂ containing contaminants. For example, when the first cleaning solution W₁ sprayed from the nozzle portion 100 is sprayed in a direction (e.g., third direction Z) opposite to the direction of gravity, the cleaning solution storage 30 may be disposed below the cleaning solution spraying device 10 along the direction of gravity. However, the disclosure is not limited thereto, and the cleaning solution storage 30 may be disposed at any position capable of storing the second cleaning solution W₂ along the direction of movement of the second cleaning solution W₂ containing contaminants in another embodiment.

According to an embodiment, the contaminants may be removed from the second cleaning solution W₂ so as to reuse the second cleaning solution W₂ containing contaminants. The first purification portion 40 may remove the contaminants contained in the second cleaning solution W₂ collected in the cleaning solution storage 30. For example, the second cleaning solution W₂ collected in the cleaning solution storage 30 may be supplied to the first purification portion 40 by using a pump 95, and the contaminants contained in the second cleaning solution W₂ may be removed by the first purification portion 40.

According to an embodiment, the first purification portion 40 may be a filter capable of removing contaminants contained in the second cleaning solution W₂, for example, the particulate matter PM. For example, when the first purification portion 40 includes a filter, a plurality of filters may be provided according to the concentration of contaminants contained in the second cleaning solution W₂, for example, the particulate matter PM. Although the particulate matter PM has been described as an example of the contaminants contained in the second cleaning solution W₂, the disclosure is not limited thereto. When the contaminants contained in the second cleaning solution W₂ include materials other than the particulate matter PM, the first purification portion 40 may also further include, in addition to the filter, a purifier that removes the materials other than particulate matter PM.

According to an embodiment, a third cleaning solution W₃ from which the contaminants have been removed by the first purification portion 40 may be stored in the first storage tank 50. The third cleaning solution W₃ stored in the first storage tank 50 may be supplied to the nozzle portion 100 by the pressurizer 80. The first cleaning solution W₁ sprayed from the nozzle portion 100 may be substantially the same as the third cleaning solution W₃ stored in the first storage tank 50. Accordingly, a recycling cycle in which the third cleaning solution W₃ in which the contaminants have been removed from the second cleaning solution W₂ is reused as the first cleaning solution W₁ may be implemented.

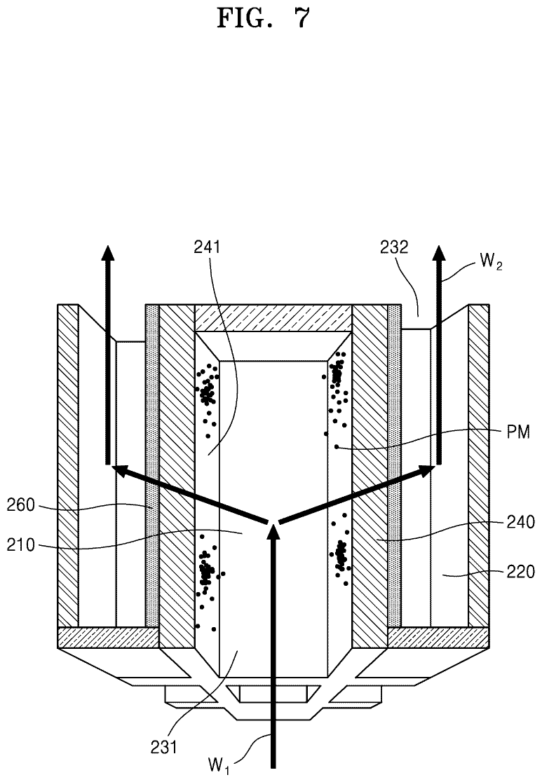

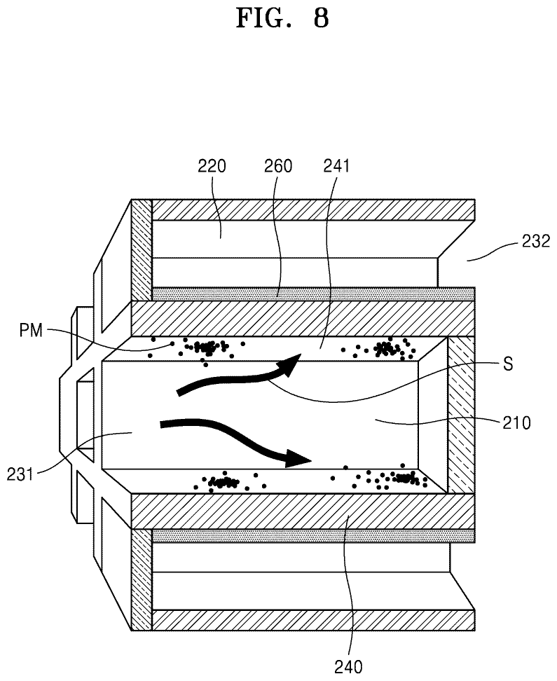

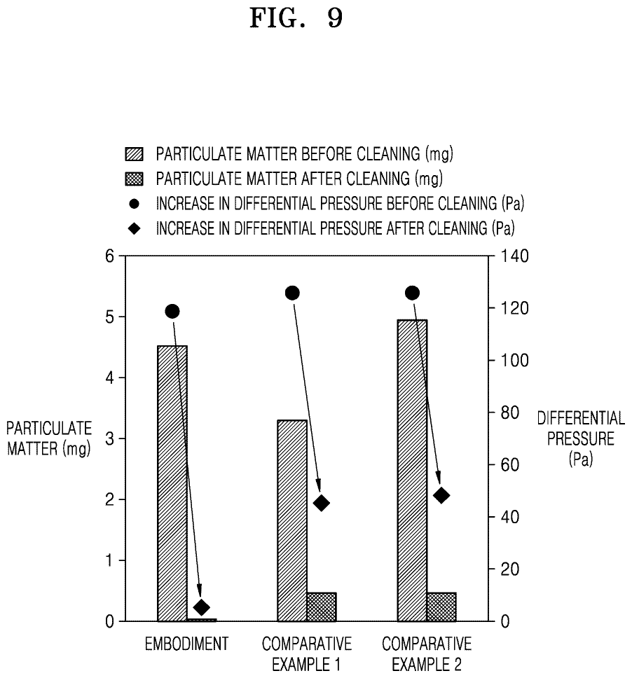

FIG. 7 is a schematic diagram illustrating purification of an air purifier according to Comparative Example 1. FIG. 8 is a schematic diagram illustrating purification of an air purifier according to Comparative Example 2. FIG. 9 is a graph for comparing purification efficiencies of air purifying filter cleaning apparatuses according to an embodiment, Comparative Example 1, and Comparative Example 2.

Referring again to FIG. 6, according to an embodiment, when the first cleaning solution W₁ sprayed from the nozzle portion 100 is introduced into the purified air outlet 232, the first cleaning solution W₁ may pass through the second channel 220 and the first channel 210 and be discharged to the outside through the contaminated air inlet 231. In this case, the air purifying filter 240 and the coating portion 260 according to an embodiment may be disposed across the flow path of the first cleaning solution W₁ between the upstream and the downstream of the flow of the first cleaning solution W₁. For example, the air purifying filter 240 and the coating portion 260 may be disposed so that the flow of the first cleaning solution W₁ sequentially passes through one surface of each of the air purifying filter 240 and the coating portion 260 and the other surface of the air purifying filter 240 opposite to the one surface thereof. For example, the coating portion 260 may be disposed upstream of the flow of the first cleaning solution W₁, compared to the air purifying filter 240. That is, the coating portion 260 may be disposed to first come into contact with the flow of the first cleaning solution W₁, compared to the air purifying filter 240.

On the other hand, referring to FIG. 7, according to Comparative Example 1, when the first cleaning solution W₁ sprayed from the nozzle portion 100 is introduced into the contaminated air inlet 231, the first cleaning solution W₁ may pass through the first channel 210 and the second channel 220 and be discharged to the outside through the purified air outlet 232. In this case, the air purifying filter 240 and the coating portion 260 according to this embodiment may be disposed across the flow path of the first cleaning solution W₁ between the upstream and the downstream of the flow of the first cleaning solution W₁. For example, the air purifying filter 240 and the coating portion 260 may be disposed so that the flow of the first cleaning solution W₁ sequentially passes through one surface of each of the air purifying filter 240 and the coating portion 260 and the other surface of the air purifying filter 240 opposite to the one surface thereof. For example, the air purifying filter 240 may be disposed upstream of the flow of the first cleaning solution W₁, compared to the coating portion 260. That is, the air purifying filter 240 may be disposed so that the air purifying filter 240 first comes into contact with the flow of the first cleaning solution W₁, compared to the coating portion 260.

As the first cleaning solution W₁ according to Comparative Example 1 first comes into contact with the air purifying filter 240, then comes into contact with the coating portion 260, and is introduced into the second channel 220, the contaminants adsorbed onto one surface 241 of the air purifying filter 240, for example, the particulate matter PM, may pass through the air purifying filter 240 and be introduced into the second channel 220. Accordingly, in the process in which the particulate matter PM adsorbed onto one surface 241 of the air purifying filter 240 passes through the air purifying filter 240 and the coating portion 260, a portion of the particulate matter PM may be adsorbed by the air purifying filter 240 and the coating portion 260, and only the remaining particulate matter PM that is not adsorbed may be introduced into the second channel 220 and then pass through the purified air outlet 232 and discharged to the outside of the air purifier 20. Accordingly, because some of the contaminants adsorbed onto one surface 241 of the air purifying filter 240 are adsorbed again onto the air purifying filter 240 and the coating portion 260, the contaminant cleaning efficiency may be lowered.

In addition, referring to FIG. 8, according to Comparative Example 2, when the air purifier 20 is immersed in the cleaning solution and ultrasonic waves S having a certain frequency are applied thereto to vibrate the particulate matter PM adsorbed onto one surface 241 of the air purifying filter 240, the particulate matter PM adsorbed onto one surface 241 of the air purifying filter 240 may be desorbed. In this case, because the flow of the cleaning solution passing through the air purifying filter 240 is not formed, the particulate matter PM desorbed from one surface 241 of the air purifying filter 240 may remain in the first channel 210. Accordingly, because a portion of the particulate matter PM desorbed from one surface 241 of the air purifying filter 240 are adsorbed again onto the air purifying filter 240, the contaminant cleaning efficiency may be lowered.

Referring to FIG. 9, the cleaning efficiency according to the embodiment of FIG. 6 and the cleaning performance according to Comparative Examples 1 and 2 of FIGS. 7 and 8 are tested as follows.

### EMBODIMENT

A cleaning process was performed by using the air purifier 20 including the air purifying filter coated with a photocatalyst.

As illustrated in FIG. 2, the air purifier 20 includes a ceramic material, and one surface 22 of the air purifier 20 in which the purified air outlet 232 is disposed has a width of 670 millimeters (mm), a length of 670 mm, and a height of 100 mm. In this case, a plurality of purified air outlets 232 may be disposed on one surface 22 of the air purifier 20 at a ratio of 212 cells per square inch (“CPSI”) of the filter. The plurality of second channels 220 may be connected to the plurality of purified air outlets 232, respectively. In addition, a plurality of contaminated air inlets 231 may be disposed on the other surface 21 of the air purifier 20 at a ratio of 212 CPSI of the filter. The plurality of first channels 210 may be connected to the plurality of contaminated air inlets 231, respectively. In this case, the air purifying filter 240 may be disposed between the first channel 210 and the second channel 220, and a photocatalyst (e.g., titanium dioxide: TiO₂) may be coated on one surface of the air purifying filter 240 adjacent to the second channel 220.

An initial differential pressure between the contaminated air inlet 231 and the purified air outlet 232, onto which no contaminants are adsorbed, is 125 pascals (Pa). The contaminants, Arizona dust A1, is adsorbed onto the air purifying filter 240 until the differential pressure between the contaminated air inlet 231 and the purified air outlet 232 reaches 250 Pa.

For example, ninety nozzles in the nozzle portion 100 are provided. As illustrated in FIG. 4, the plurality of nozzles in the nozzle portion 100 are spaced apart from each other at intervals of 6 centimeters (cm) along the first direction X and at intervals of 5 cm along the second direction Y. The plurality of nozzles in the nozzle portion 100 are disposed to face one surface 22 of the air purifier 20 in which the purified air outlet 232 is disposed. Water is discharged from each of the plurality of nozzles in the nozzle portion 100 as the cleaning solution, and the water is discharged at a flow rate of 150 L/s to 200 L/min and a flow rate of 1.0 cm/s to 1.5 cm/s.

### Comparative Example 1

The configuration of Comparative Example 1 is the same as the configuration of the embodiment, except that a nozzle portion 100 is disposed to face one surface 21 of an air purifier 20 in which a contaminated air inlet 231 is disposed.

### Comparative Example 2

The configuration of Comparative Example 2 is the same as the configuration of the embodiment, except that an air purifier 20 is immersed in water, which is a cleaning solution, and ultrasonic waves having a wavelength of 40 kilohertz (kHz) are applied thereto for 30 minutes.

In the case of the embodiment, it may be confirmed that all contaminants adsorbed onto the air purifier 20 have been removed. In addition, it may be confirmed that an increase in differential pressure between the contaminated air inlet 231 and the purified air outlet 232 of the air purifier 20 is 0 Pa, that is, the differential pressure is returned to the initial differential pressure of 125 Pa.

In the case of Comparative Example 1, it may be confirmed that some of the contaminants adsorbed onto the air purifier 20 remain. In addition, it may be confirmed that the differential pressure between the contaminated air inlet 231 and the purified air outlet 232 of the air purifier 20 has increased by 40 Pa, compared to the initial differential pressure of 125 Pa.

In the case of Comparative Example 2, it may be confirmed that some of the contaminants adsorbed onto the air purifier 20 remain. In addition, it may be confirmed that the differential pressure between the contaminated air inlet 231 and the purified air outlet 232 of the air purifier 20 has increased by 40 Pa, compared to the initial differential pressure of 125 Pa.

Referring to the embodiment and Comparative Examples 1 and 2, it may be confirmed that, in Comparative Examples 1 and 2, even when the cleaning process for the air purifier 20 is completed, some of the contaminants adsorbed onto one surface 241 of the air purifying filter 240 remain on the air purifying filter 240. It may be confirmed that the differential pressure of the air purifier 20 may increase as some contaminants remain in the air purifying filter 240, and thus, the operating efficiency of the air purifier 20 may be lowered.

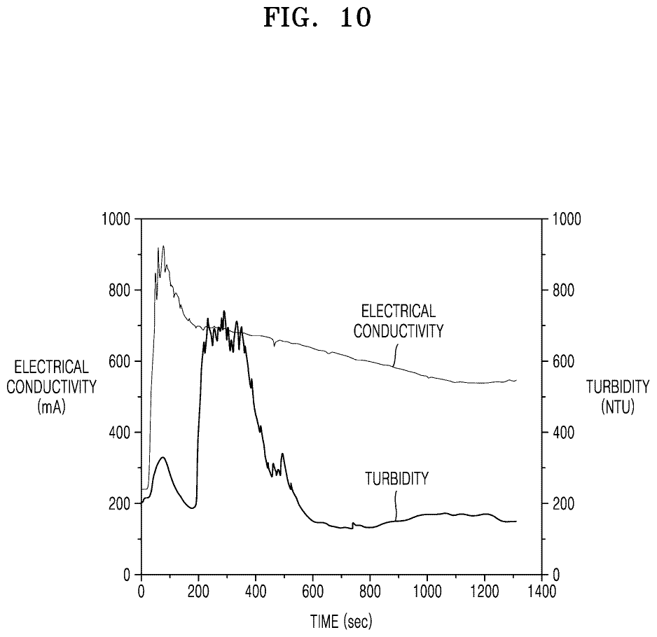

FIG. 10 is a graph showing a change in electrical conductivity and turbidity of an air purifier according to an embodiment.

Referring again to FIG. 1, the cleaning process for the air purifier 20 according to an embodiment may be repeated according to the contamination level of the air purifying filter 240. According to an embodiment, the first sensor 91 and the second sensor 92 may sense the contamination level of the air purifier 20, for example, the air purifying filter 240.

For example, the first sensor 91 may sense the contamination level of the air purifying filter 240 by sensing the electrical conductivity (milliampere: mA) of the air purifying filter 240. For example, when the particulate matter PM is adsorbed onto one surface 241 of the air purifying filter 240, the electrical conductivity of the air purifying filter 240 may increase. In this case, the first sensor 91 may sense the contamination level of the air purifying filter 240 by sensing whether the electrical conductivity of the air purifying filter 240 increases or decreases.

In addition, for example, the second sensor 92 may sense the contamination level of the air purifying filter 240 by sensing the turbidity (nephelometric turbidity units: NTU) of the air purifying filter 240. For example, when the particulate matter PM is adsorbed onto one surface 241 of the air purifying filter 240, the turbidity of the air purifying filter 240 may increase. In this case, the second sensor 92 may sense the contamination level of the air purifying filter 240 by sensing whether the turbidity of the air purifying filter 240 increases or decreases.

According to an embodiment, the processor 94 may perform control to repeat the recycling process of cleaning the air purifying filter 240 by supplying the third cleaning solution W₃ to the nozzle portion 100 according to the contamination level of the air purifying filter 240 sensed by the first sensor 91 or the second sensor 92. For example, when the electrical conductivity of the air purifying filter 240 sensed by the first sensor 91 or the turbidity of the air purifying filter 240 sensed by the second sensor 92 exceeds a reference value, the processor 94 may control the pressurizer 80 to supply the third cleaning solution W₃ stored in the first storage tank 50 to the nozzle portion 100. Accordingly, the first cleaning solution W₁ may be sprayed from the nozzle portion 100 so that the recycling process for the air purifying filter 240 is continued. Because the second cleaning solution W₂ containing the contaminants removed from the air purifying filter 240 is purified again by the first purification portion 40 and then reused, the recycling process for purifying the air purifying filter 240 may be repeated.

As the recycling process for purifying the air purifying filter 240 is repeated, the electrical conductivity of the air purifying filter 240 sensed by the first sensor 91 and the turbidity of the air purifying filter 240 sensed by the second sensor 92 may be reduced. In an embodiment, when the electrical conductivity of the air purifying filter 240 sensed by the first sensor 91 or the turbidity of the air purifying filter 240 sensed by the second sensor 92 is sensed to be less than a reference value, the processor 94 may control the pressurizer 80 to stop the recycling process of supplying the third cleaning solution W₃ stored in the first storage tank 50 to the nozzle portion 100.

Referring to FIGS. 1 and 10, when the cleaning process for the air purifying filter 240 according to an embodiment is performed, the electrical conductivity and the turbidity of the air purifying filter 240 may be measured by using the first sensor 91 and the second sensor 92. It may be confirmed that the electrical conductivity and the turbidity of the air purifying filter 240 was increased before cleaning, was decreased as the cleaning process was performed, and was stabilized after a certain time. Accordingly, the processor 94 may perform the recycling process for up to 1,200 seconds at which the electrical conductivity and the turbidity of the air purifying filter 240 are reduced below the reference value and thus stabilized.

Table 1 below shows a result of measuring a cleaning rate at which contaminants are removed from the air purifier 20 by measuring the weight of the air purifier 20 before cleaning and the weight of the air purifier 20 after cleaning when the cleaning process is performed to a point where the electrical conductivity and the turbidity of the air purifying filter 240 are reduced below the reference value.

TABLE 1

| | | Weight (kg) of air | | |
|---|---|---|---|---|
| | | purifier onto which | Weight (kg) of | |
| Number of | Weight (kg) of air | contaminants are | air purifier after | Cleaning |
| operations | purifier before use | adsorbed | cleaning | rate (%) |
| 1 | 18.09 | 18.81 | 18.19 | 86.1 |
| 2 | 18.17 | 18.72 | 18.23 | 89.1 |
| 3 | 17.88 | 18.58 | 17.99 | 84.3 |
| 4 | 18.07 | 18.48 | 18.13 | 85.4 |
| 5 | 17.91 | 18.72 | 17.91 | 100.0 |
| 6 | 18.05 | 18.88 | 18.11 | 92.8 |
| 7 | 18.17 | 18.88 | 18.29 | 83.1 |
| 8 | 18.05 | 18.78 | 18.05 | 100.0 |

| | |
|---|---|
| average | 90.1 |

$$Cleaning rate = \frac{weight of air purifier with adsorbed contaminants - weight of air purifier after cleaning}{weight of air purifier with adsorbed contaminants - weight of air purifier before use} \times 100$$

Referring to Table 1, it may be confirmed that, when the cleaning process is performed up to a point where the electrical conductivity and the turbidity of the air purifying filter 240 are reduced below the reference value, the cleaning rate of the air purifier 20 progresses up to an average of 90%.

Referring again to FIG. 1, when the recycling process in which the second cleaning solution W₂ containing the contaminants removed from the air purifying filter 240 as described above is purified again by the first purification portion 40 and then reused is repeated several times, the contaminant removal efficiency of the first purification portion 40 may be reduced. The third sensor 93 according to an embodiment may sense the contamination level of the third cleaning solution W₃ stored in the first storage tank 50. For example, the third sensor 93 may sense the electrical conductivity of the third cleaning solution W₃ stored in the first storage tank 50.

According to an embodiment, when the electrical conductivity of the third cleaning solution W₃ sensed by the third sensor 93 exceeds the reference value, the processor 94 may remove the contaminants contained in the third cleaning solution W₃ by using the second purification portion 60. As the contaminants contained in the third cleaning solution W₃ are removed by using the second purification portion 60, a fourth cleaning solution W₄ with a reduced concentration of contaminants may be stored in the second storage tank 70. According to an embodiment, when the second purification portion 60 is operated, the processor 94 may supply the fourth cleaning solution W₄ stored in the second storage tank 70 to the nozzle portion 100. In this case, the first cleaning solution W₁ sprayed from the nozzle portion 100 may be substantially the same as the fourth cleaning solution W₄ stored in the second storage tank 70. Accordingly, a recycling cycle in which the fourth cleaning solution W₄ in which the contaminants have been removed from the second cleaning solution W₂ is reused as the first cleaning solution W₁ may be implemented.

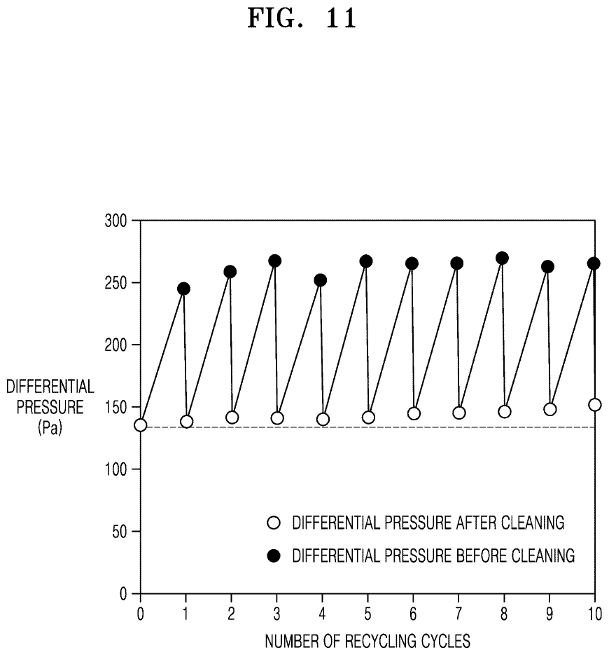

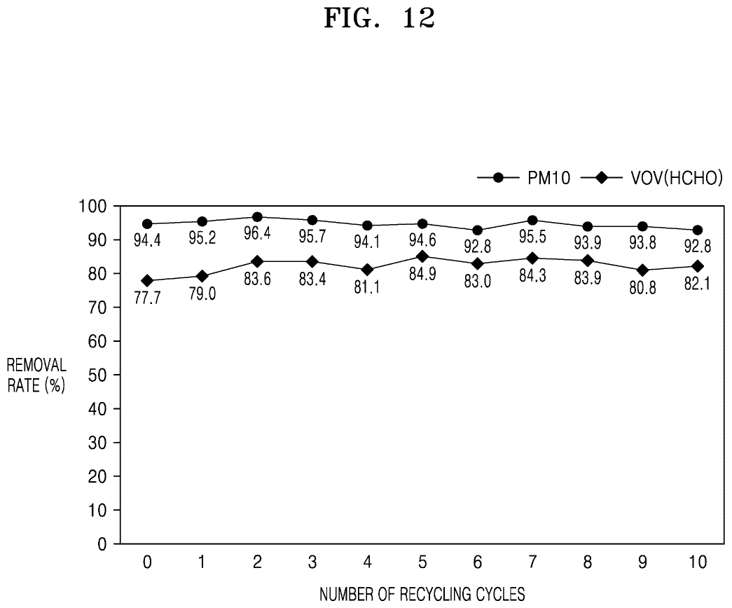

FIG. 11 is a graph showing a change in differential pressure before and after cleaning according to the number of recycling cycles of an air purifying filter according to an embodiment. FIG. 12 is a graph showing a contaminant removal rate and a change in differential pressure according to the number of recycling cycles of an air purifying filter according to an embodiment.

As described above, the first purification portion 40 or the second purification portion 60 removes contaminants from the second cleaning solution W₂ having removed the contaminants adsorbed onto the air purifying filter 240, and thus, the second cleaning solution W₂ may be continuously reused. Therefore, the air purifying filter cleaning apparatus 1 according to an embodiment may repeatedly clean the air purifying filter 240 a plurality of times with a constant cleaning power.

Referring to FIG. 11, it may be confirmed that, when the air purifying filter cleaning apparatus 1 according to an embodiment cleans the air purifying filter 240 ten times, the differential pressure between the contaminated air inlet 231 and the purified air outlet 232 of the air purifier 20 is returned to the initial differential pressure of 125 Pa after cleaning.

In addition, referring to FIG. 12, it may be confirmed that, when the air purifying filter cleaning apparatus 1 according to an embodiment cleans the air purifying filter 240 ten times and the air purifier 20 is reused, 92.8% to 96.4% of particulate matter PM10 contained in contaminated air Aᵢₙ introduced into the contaminated air inlet 231 of the air purifier 20 is removed, and 92.8% to 96.4% of formaldehyde (CH₂O), a volatile organic compound, is removed.

Accordingly, it may be confirmed that the air purification performance of the air purifier 20 is maintained even when the recycling process is performed a plurality of times by using the air purifying filter cleaning apparatus 1 according to an embodiment.

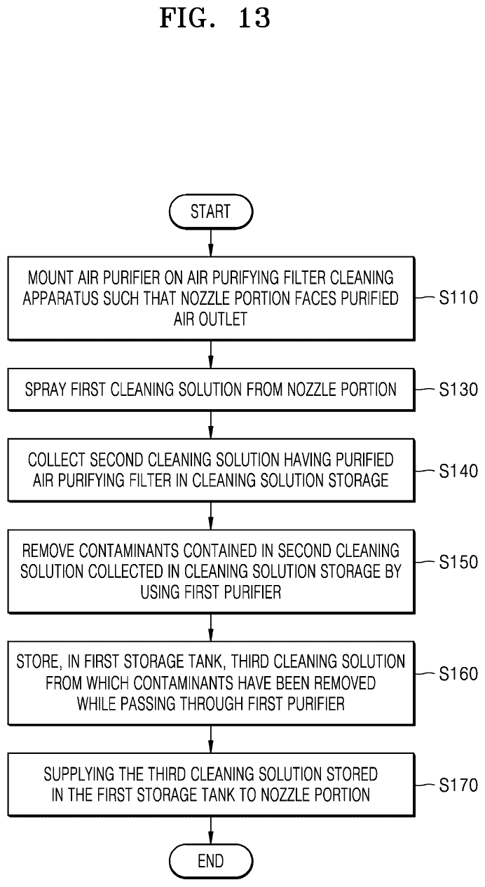

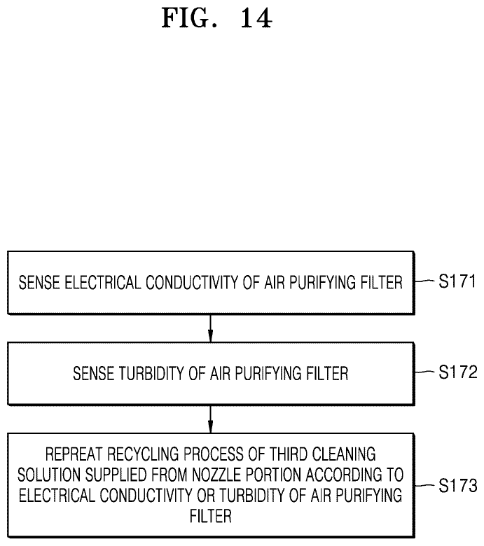

FIG. 13 is a flowchart showing an operating method of the air purifying filter cleaning apparatus, according to an embodiment. FIG. 14 is a flowchart showing an operating method of the air purifying filter cleaning apparatus, according to an embodiment.

Referring to FIG. 13, according to an embodiment, the air purifier 20 may be mounted on the air purifying filter cleaning apparatus 1 such that the nozzle portion 100 faces the purified air outlet 232 (S110). For example, as illustrated in FIGS. 3 and 4, the fastening portion 170 may fix the air purifier 20 to the cleaning solution spraying device 10 such that one surface of the air purifier 20 where the purified air outlet 232 is disposed, for example, the other surface 22 where the contaminated air inlet 231 is not disposed, faces the nozzle portion 100. In this case, the fastening portion 170 may be provided in plurality and disposed to be movable on one plane (an X-Y plane). Accordingly, the fastening portion 170 may fix the air purifier 20 to the cleaning solution spraying device 10 so that the other surface 22 of the air purifier 20 faces the nozzle portion 100 so as to correspond to the air purifier 20 having a different area and shape.

In addition, in an embodiment, when a plurality of purified air outlets 232 are provided, a plurality of nozzles in the nozzle portion 100 disposed to face the plurality of purified air outlets 232 may also be provided. When a plurality of nozzles in the nozzle portion 100 are provided, the plurality of nozzles in the nozzle portion 100 may be spaced apart from each other at certain intervals. For example, a first interval X₁ along a first direction X and a second interval Y₁ along a second direction Y perpendicular to the first direction may be adjusted differently between nozzles disposed adjacent to each other among the plurality of nozzles in the nozzle portion 100.

As described above, each of the plurality of nozzles in the nozzle portion 100 may be movable along the first direction X or the second direction Y. In addition, as a relative position of the air purifier 20 fixed to the cleaning solution spraying device 10 is adjusted by the fastening portion 170, the positions of the plurality of nozzles in the nozzle portion 100 and the positions of the plurality of purified air outlets 232 may be relatively adjusted.

Next, the first cleaning solution W₁ may be sprayed from the nozzle portion 100 (S130). According to an embodiment, the first cleaning solution W₁ discharged from the nozzle portion 100 may have a certain flow velocity and a certain flow rate so that the contaminants adsorbed onto the air purifying filter 240 are desorbed from the air purifying filter 240.

According to an embodiment, the flow velocity and the flow rate of the first cleaning solution W₁ discharged from the nozzle portion 100 may be adjusted by the pressurizer 80 that apply pressure to the first cleaning solution W₁. For example, the processor 94 may control the pressurizer 80 to adjust the flow velocity and the flow rate of the first cleaning solution W₁ discharged from the nozzle portion 100 according to at least one of the type of the particulate matter PM adsorbed onto the air purifying filter 240, the thickness and porosity of the air purifying filter 240 and the coating portion 260, the cross-sectional area of the purified air outlet 232 disposed on one surface 22 of the air purifier 20, or the relative positional relationship between the purified air outlet 232 and the nozzle portion 100.

Next, the second cleaning solution W₂ having purified the air purifying filter 240 may be collected in the cleaning solution storage 30 (S140). According to an embodiment, the first cleaning solution W₁ may remove the contaminants adsorbed onto one surface 241 of the air purifying filter 240 from the air purifying filter 240. The second cleaning solution W₂ having purified the air purifying filter 240 may be discharged to the outside of the air purifier 20 through the contaminated air inlet 231. The second cleaning solution W₂ discharged to the outside of the air purifier 20 may be collected in the cleaning solution storage 30. According to an embodiment, the cleaning solution storage 30 may be a storage that temporarily stores the second cleaning solution W₂ containing contaminants.

Next, the contaminants contained in the second cleaning solution W₂ collected in the cleaning solution storage 30 may be removed by using the first purification portion 40 (S150). According to an embodiment, the contaminants may be removed from the second cleaning solution W₂ so as to reuse the second cleaning solution W₂ containing contaminants. The first purification portion 40 may remove the contaminants contained in the second cleaning solution W₂ collected in the cleaning solution storage 30. For example, the second cleaning solution W₂ collected in the cleaning solution storage 30 may be supplied to the first purification portion 40 by using the pump 95, and the contaminants contained in the second cleaning solution W₂ may be removed by the first purification portion 40.

Next, the third cleaning solution W₃ from which the contaminants have been removed by passing through the first purification portion 40 may be stored in the first storage tank 50 (S160). According to an embodiment, when the recycling process in which the second cleaning solution W₂ containing the contaminants removed from the air purifying filter 240 is purified again by the first purification portion 40 and then reused is repeated over a certain period of time, the contaminant removal efficiency of the first purification portion 40 may be reduced. The third sensor 93 according to an embodiment may sense the contamination level of the third cleaning solution W₃ stored in the first storage tank 50.

According to an embodiment, when the contamination level of the third cleaning solution W₃ sensed by the third sensor 93 exceeds a reference value, the processor 94 may additionally remove the contaminants contained in the third cleaning solution W₃ by using the second purification portion 60. As the contaminants contained in the third cleaning solution W₃ are removed by using the second purification portion 60, a fourth cleaning solution W₄ with a reduced concentration of contaminants may be stored in the second storage tank 70. According to an embodiment, when the second purification portion 60 is operated, the processor 94 may supply the fourth cleaning solution W₄ stored in the second storage tank 70 to the nozzle portion 100. In this case, the first cleaning solution W₁ sprayed from the nozzle portion 100 may be substantially the same as the fourth cleaning solution W₄ stored in the second storage tank 70.

Next, the third cleaning solution W₃ stored in the first storage tank 50 may be supplied to the nozzle portion 100 (S170). According to an embodiment, the third cleaning solution W₃ or the fourth cleaning solution W₄ in which the contaminants have been removed from the second cleaning solution W₂ by the first purification portion 40 may be stored in the first storage tank 50 or the second storage tank 70. The third cleaning solution W₃ or the fourth cleaning solution W₄ may be supplied to the nozzle portion 100 by the pressurizer 80. The first cleaning solution W₁ sprayed from the nozzle portion 100 may be substantially the same as the third cleaning solution W₃ or the fourth cleaning solution W₄ stored in the first storage tank 50 or the second storage tank 70. Accordingly, a recycling cycle in which the third cleaning solution W₃ or the fourth cleaning solution W₄ in which the contaminants have been removed from the second cleaning solution W₂ is reused as the first cleaning solution W₁ may be implemented. According to an embodiment, a recycling cycle in which the third cleaning solution W₃ or the fourth cleaning solution W₄ is reused as the first cleaning solution W₁ may be repeated according to the cleaning degree of the air purifying filter 240.

Referring to FIG. 14, according to an embodiment, the electrical conductivity of the air purifying filter 240 may be sensed (S171). For example, the first sensor 91 may sense the contamination level of the air purifying filter 240 by sensing the electrical conductivity of the air purifying filter 240. For example, when the particulate matter PM is adsorbed onto one surface 241 of the air purifying filter 240, the electrical conductivity of the air purifying filter 240 may increase. In this case, the first sensor 91 may sense the contamination level of the air purifying filter 240 by sensing whether the electrical conductivity of the air purifying filter 240 increases or decreases.

Next, the turbidity of the air purifying filter 240 may be sensed (S172). For example, the second sensor 92 may sense the contamination level of the air purifying filter 240 by sensing the turbidity of the air purifying filter 240. For example, when the particulate matter PM is adsorbed onto one surface 241 of the air purifying filter 240, the turbidity of the air purifying filter 240 may increase. In this case, the second sensor 92 may sense the contamination level of the air purifying filter 240 by sensing whether the turbidity of the air purifying filter 240 increases or decreases.

Next, the recycling process of the third cleaning solution W₃ supplied from the nozzle portion 100 may be repeated according to the electrical conductivity or the turbidity of the air purifying filter 240 (S173). According to an embodiment, the processor 94 may perform control to repeat the recycling process of cleaning the air purifying filter 240 by supplying the third cleaning solution W₃ to the nozzle portion 100 according to the contamination level of the air purifying filter 240 sensed by the first sensor 91 or the second sensor 92. For example, when the electrical conductivity of the air purifying filter 240 sensed by the first sensor 91 or the turbidity of the air purifying filter 240 sensed by the second sensor 92 exceeds a reference value, the processor 94 may control the pressurizer 80 to supply the third cleaning solution W₃ stored in the first storage tank 50 to the nozzle portion 100. Accordingly, the first cleaning solution W₁ may be sprayed from the nozzle portion 100 so that the purifying process for the air purifying filter 240 is continued.

As the recycling process for purifying the air purifying filter 240 is repeated, the electrical conductivity of the air purifying filter 240 sensed by the first sensor 91 and the turbidity of the air purifying filter 240 sensed by the second sensor 92 may be reduced. In an embodiment, when the electrical conductivity of the air purifying filter 240 sensed by the first sensor 91 or the turbidity of the air purifying filter 240 sensed by the second sensor 92 is sensed to be less than a reference value, the processor 94 may control the pressurizer 80 to stop the recycling process of supplying the third cleaning solution W₃ stored in the first storage tank 50 to the nozzle portion 100.

According to the air purifying filter cleaning apparatus and the operating method of the air purifying filter cleaning apparatus described above, contaminants adsorbed onto the air purifying filter may be removed by using the cleaning solution, and thus, the air purifying filter may be reused.

In addition, the air purifying filter cleaning apparatus, in which the cleaning solution is reused so that the consumption of the cleaning solution is reduced, and the weight of the air purifying filter cleaning apparatus is reduced, and the operating method of the air purifying filter cleaning apparatus may be provided.

In addition, the air purifying filter cleaning apparatus, in which the cleaning solution sprayed from the nozzle portion is introduced into the purified air outlet to improve the cleaning rate for the air purifying filter, and the operating method of the air purifying filter cleaning apparatus may be provided.

In addition, the air purifying filter cleaning apparatus, in which energy efficiency is improved because no heat source is used in the process of removing the contaminants adsorbed onto the air purifying filter, and the operating method of the air purifying filter cleaning apparatus may be provided.

Furthermore, the air purifying filter cleaning apparatus, in which design convenience is improved by configuring the nozzle portion to spray the cleaning solution to correspond to air purifying filters of various specifications, and the operating method of the air purifying filter cleaning apparatus may be provided.

Moreover, the air purifying filter cleaning apparatus, in which the cleaning state of the air purifying filter is sensed to determine whether to recycle the air purifying filter, and the operating method of the air purification filter cleaning apparatus may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An air purifying filter cleaning apparatus for cleaning an air purifier including a contaminated air inlet into which contaminated air is introduced and a purified air outlet through which purified air is discharged, wherein an air purifying filter is disposed between the contaminated air inlet and the purified air outlet, the air purifying filter cleaning apparatus comprising:
a nozzle portion disposed to face the purified air outlet and configured to discharge a first cleaning solution to the purified air outlet;
a cleaning solution storage in which a second cleaning solution discharged from the contaminated air inlet is collected;
a first purifier configured to remove contaminants contained in the second cleaning solution received from the cleaning solution storage;
a first storage tank in which a third cleaning solution, which is a solution remaining after the contaminants are removed from the second cleaning solution by the first purifier, is stored; and
a pressurizer configured to supply the third cleaning solution stored in the first storage tank to the nozzle portion.

2. The air purifying filter cleaning apparatus of claim 1, wherein the nozzle portion includes a plurality of nozzles, and the plurality of nozzles are spaced apart from each other at certain intervals.

3. The air purifying filter cleaning apparatus of claim 2, wherein a first interval along a first direction and a second interval along a second direction perpendicular to the first direction between nozzles disposed adjacent to each other among the plurality of nozzles are adjustable differently from each other.

4. The air purifying filter cleaning apparatus of claim 1, wherein the first cleaning solution discharged from the nozzle portion comprises at least one of water or ethanol.

5. The air purifying filter cleaning apparatus of claim 1, wherein the first cleaning solution is discharged from the nozzle portion at a flow rate of about 150 liters per minute (L/min) to about 200 L/min.

6. The air purifying filter cleaning apparatus of claim 1, wherein the first cleaning solution is discharged from the nozzle portion at a flow velocity of about 1.0 centimeter per second (cm/s) to about 1.5 cm/s.

7. The air purifying filter cleaning apparatus of claim 1, wherein the pressurizer is further configured to adjust a flow velocity and a flow rate of the first cleaning solution by applying pressure to the first cleaning solution discharged from the nozzle portion.

8. The air purifying filter cleaning apparatus of claim 1, further comprising a fastening portion configured to fix the air purifier such that one surface of the air purifier where the purified air outlet is disposed faces the nozzle portion.

9. The air purifying filter cleaning apparatus of claim 1, further comprising a first sensor configured to sense electrical conductivity of the air purifying filter.

10. The air purifying filter cleaning apparatus of claim 9, further comprising a second sensor configured to sense turbidity of the air purifying filter.

11. The air purifying filter cleaning apparatus of claim 10, further comprising a processor configured to perform control to repeat a recycling process in which the third cleaning solution is supplied to the nozzle portion according to the electrical conductivity or the turbidity of the air purifying filter sensed by the first sensor or the second sensor.

12. The air purifying filter cleaning apparatus of claim 1, further comprising a third sensor configured to sense electrical conductivity of the third cleaning solution.

13. The air purifying filter cleaning apparatus of claim 12, further comprising:
a second purifier configured to remove contaminants contained in the third cleaning solution received from the first storage tank; and
a second storage tank in which a fourth cleaning solution, which is a solution remaining after the contaminants are removed from the third cleaning solution by the second purifier, is stored,
wherein the pressurizer is further configured to supply the fourth cleaning solution stored in the second storage tank to the nozzle portion.

14. The air purifying filter cleaning apparatus of claim 1, wherein the air purifying filter comprises a porous filter, and
the air purifier further includes a coating portion coated with a catalyst on one surface of the air purifying filter.

15. An operating method of the air purifying filter cleaning apparatus of claim 1, the operating method comprising:
mounting the air purifier on the air purifying filter cleaning apparatus such that the nozzle portion faces the purified air outlet;
spraying the first cleaning solution from the nozzle portion;
collecting, in the cleaning solution storage, the second cleaning solution discharged from the contaminated air inlet;
removing contaminants contained in the second cleaning solution collected in the cleaning solution storage by using the first purifier;
storing, in the first storage tank, the third cleaning solution; and
supplying the third cleaning solution stored in the first storage tank to the nozzle portion.

16. The operating method of claim 15, wherein the nozzle portion includes a plurality of nozzles, and the plurality of nozzles are spaced apart from each other at certain intervals, and
a first interval along a first direction and a second interval along a second direction perpendicular to the first direction between nozzles disposed adjacent to each other among the plurality of nozzles are adjustable differently from each other according to a cross-sectional area and an arrangement interval of the purified air outlet.

17. The operating method of claim 15, further comprising:
adjusting a flow velocity and a flow rate of the first cleaning solution discharged from the nozzle portion.

18. The operating method of claim 15, further comprising:
sensing electrical conductivity of the air purifying filter.

19. The operating method of claim 18, further comprising:
sensing turbidity of the air purifying filter.

20. The operating method of claim 19, further comprising:
repeating a recycling process of the third cleaning solution supplied from the nozzle portion according to the electrical conductivity or the turbidity of the air purifying filter.
